(19) United States
(12) Patent Application Publication
(10) Pub. No.: US 2026/0169901 A1
(43) Pub. Date: Jun. 18, 2026

(54) CODE PATH MULTI-LEVEL COVERAGE TEST CASE SELECTION ALGORITHM

(71) Applicant: Dell Products L.P., Round Rock, TX (US)

(72) Inventors: Michael Chi Chen, Chengdu (CN); Kiko Wang, Chengdu (CN); Jessica Ye, Chengdu (CN); David Wu, Chengdu (CN); Zhao Li, Chengdu (CN)

(73) Assignee: Dell Products L.P., Round Rock, TX (US)

(21) Appl. No.: 19/011,764

(22) Filed: Jan. 7, 2025

(30) Foreign Application Priority Data
Dec. 17, 2024 (CN) 202411863790.6

(51) Int. Cl. G06F 11/3668

(52) U.S. Cl. CPC G06F 11/3684; G06F 11/3676

(57) ABSTRACT

Methods, system, and non-transitory processor-readable storage medium for code path test selection system are provided herein. An example method includes the code path test selection system defining a multi-level test coverage target based on code paths associated with a plurality of test cases, where the multi-levels correspond to different test hit rates. The code path test selection system generates a test target code path vector representing code paths to be tested, comprising vector elements weighted based on importance of the corresponding code paths and generates test case code path vectors representing code paths covered by the plurality of test cases. The code path test selection system selects a set of test cases from the plurality of test cases based on the test case code path vector and the test target code path vector. A CI/CD pipeline system executes the set of test cases on a test system.

### FIELD

The field relates generally to selecting test cases based on code path for multi-level coverage.

### BACKGROUND

In a software project lifecycle, source code is updated to add new features and fix issues/bugs that are discovered. Selecting suitable test cases to test these new features and bug fixes is an important step in the software project lifecycle.

### SUMMARY

Illustrative embodiments provide techniques for implementing a code path test selection system in a storage system. For example, in illustrative embodiments a code path test selection system defines a multi-level test coverage target based on code paths associated with a plurality of test cases, where the multi-levels correspond to different test hit rates. The code path test selection system generates a test target code path vector representing code paths to be tested, comprising vector elements weighted based on importance of the corresponding code paths. The code path test selection system generates test case code path vectors representing code paths covered by the plurality of test cases. The code path test selection system selects a set of test cases from the plurality of test cases based on the test case code path vector and the test target code path vector. A Continuous Integration/Continuous Delivery (CI/CD) pipeline system executes the set of test cases on a test system to provide the multi-level test coverage. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a code path test selection system, in an illustrative embodiment.

FIG. 2 shows a flow diagram of a process for a code path test selection system, in an illustrative embodiment.

FIG. 3 illustrates the principle of multi-level code path coverage test selection, in an illustrative embodiment.

FIG. 4 illustrates the relationship between each vector for the multi-level test coverage based on code path, in an example embodiment.

FIG. 5 illustrates the flow chart of selecting the set of test cases, in an illustrative embodiment.

FIG. 6 illustrates the case index and the test case code path vector, in an illustrative embodiment.

FIG. 7 illustrates the sorted test case code path vector, in an illustrative embodiment.

FIG. 8 illustrates a first step of iteratively generating of the set of test cases, in an example embodiment.

FIG. 9 illustrates a second step of iteratively generating of the set of test cases, in an example embodiment.

FIG. 10 illustrates the twelfth step of iteratively generating of the set of test cases, in an example embodiment.

FIG. 11 illustrates the last step of iteratively generating of the set of test cases, in an example embodiment.

FIGS. 12 and 13 show examples of processing platforms that may be utilized to implement at least a portion of a code path test selection system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a code path test selection system, which technique may be used to ensure multi-level testing of key code paths where a code path test selection system defines a multi-level test coverage target based on code paths associated with a plurality of test cases, where the multi-levels correspond to different test hit rates. The code path test selection system generates a test target code path vector representing code paths to be tested, comprising vector elements weighted based on importance of the corresponding code paths. The code path test selection system generates test case code path vectors representing code paths covered by the plurality of test cases. The code path test selection system selects a set of test cases from the plurality of test cases based on the test case code path vector and the test target code path vector. A Continuous Integration/Continuous Delivery (CI/CD) pipeline system executes the set of test cases on a test system to provide the multi-level test coverage.

Conventional technologies fail to select test cases for testing source code change requirements, such as source code updates, new features and bug fixes based on code paths, to ensure that the selected test cases accurately target the required test points. Conventional technologies select test cases to test code updates using a binary method; either execute the test case or not to execute the test case, but conventional technologies fail to consider the testing intensity of various testing requirements. Conventional technologies fail to recognize that significant test code paths require a more focused and repeated testing, and lack quantitative methods to achieve multiple coverage of different code paths. Conventional technologies fail to support multi-leveled quantitative test coverage of key code paths, ensuring that the key code paths of the key test code modules are covered multiple times to achieve an overall better test quality. Conventional technologies fail to achieve graded test coverage of testing objectives by multi-level test code path coverage to ensure multiple tests of key modules.

By contrast, in at least some implementations in accordance with the current technique as described herein, multi-level test code path coverage is achieved to optimize testing quality by a code path test selection system that defines a multi-level test coverage target based on code paths associated with a plurality of test cases, where the multi-levels correspond to different test hit rates. The code path test selection system generates a test target code path vector representing code paths to be tested, comprising vector elements weighted based on importance of the corresponding code paths. The code path test selection system generates test case code path vectors representing code paths covered by the plurality of test cases. The code path test selection system selects a set of test cases from the plurality of test cases based on the test case code path vector and the test target code path vector. A Continuous Integration/Continuous Delivery (CI/CD) pipeline system executes the set of test cases on a test system to provide the multi-level test coverage.

Thus, a goal of the current technique is to provide a method and a system for providing a code path test selection system that selects test cases for testing source code change requirements, such as source code updates, new features and bug fixes based on code paths, to ensure that the selected test cases accurately target the required test points. Another goal is to select test cases to test source code by considering the testing intensity of various testing requirements. Another goal is to recognize that significant test code paths require a more focused and repeated testing, and to apply quantitative methods to achieve multiple coverage of different code paths. Another goal is to support a multiple leveled quantitative test coverage of key code paths, ensuring that the key code paths of the key test code modules are covered multiple times to achieve an overall better test quality. Yet another goal is to achieve graded test coverage of testing objectives by multi-level test code path coverage to ensure multiple tests of key modules.

In at least some implementations in accordance with the current technique described herein, the use of a code path test selection system can provide one or more of the following advantages: providing a method and a system for selecting test cases for testing source code change requirements, such as source code updates, new features and bug fixes based on code paths, ensuring that the selected test cases accurately target the required test points, selecting test cases to test source code by considering the testing intensity of various testing requirements, recognizing that significant test code paths require a more focused and repeated testing, and applying quantitative methods to achieve multiple coverage of different code paths, supporting a multiple leveled quantitative test coverage of key code paths, ensuring that the key code paths of the key test code modules are covered multiple times to achieve an overall better test quality, and achieving graded test coverage of testing objectives by multi-level test code path coverage to ensure multiple tests of key modules.

In contrast to conventional technologies, in at least some implementations in accordance with the current technique as described herein, multi-level test code path coverage is achieved to optimize testing quality by a code path test selection system that defines a multi-level test coverage target based on code paths associated with a plurality of test cases, where the multi-levels correspond to different test hit rates. The code path test selection system generates a test target code path vector representing code paths to be tested, comprising vector elements weighted based on importance of the corresponding code paths. The code path test selection system generates test case code path vectors representing code paths covered by the plurality of test cases. The code path test selection system selects a set of test cases from the plurality of test cases based on the test case code path vector and the test target code path vector. A Continuous Integration/Continuous Delivery (CI/CD) pipeline system executes the set of test cases on a test system to provide the multi-level test coverage.

In an example embodiment of the current technique, the CI/CD pipeline system triggers the code path test selection system to select the set of test cases to ensure multiple testing of key code paths.

In an example embodiment of the current technique, the multi-level test coverage target enables digital quantification of testing strengths of the plurality of test cases.

In an example embodiment of the current technique, the code path test selection system analyzes the code paths of the plurality of test cases at the module level as the smallest calling unit.

In an example embodiment of the current technique, the test target code path vector is generated by analyzing code push requests to identify modified code and related code paths associated with the modified code, where the plurality of test cases comprise the modified code.

In an example embodiment of the current technique, the code path test selection system incorporates the modified code paths and related code paths into the test target code path vector.

In an example embodiment of the current technique, the weighting of vector elements in the test target code path vector is based on factors comprising complexity of code modification, impact on other modules, and criticality of the module.

In an example embodiment of the current technique, the weighting of the vector elements is based on low, medium, and high importance levels.

In an example embodiment of the current technique, the weights are assigned numerical values, with higher values corresponding to higher importance levels.

In an example embodiment of the current technique, the code path test selection system represents the test target code path vector as a 1×n vector, where n indicates a number of code paths in the plurality of test cases.

In an example embodiment of the current technique, each element in the test target code path vector is set to 1 if the corresponding code path has changed, and set to 0 if the corresponding code path has not changed.

In an example embodiment of the current technique, the code path test selection system represents each test case code path vector as a 1×n vector, where n indicates a number of code paths in the plurality of test cases.

In an example embodiment of the current technique, each test case code path vector is set to 1 if the corresponding code path is covered by the test case, and set to 0 if the corresponding code path is not covered.

In an example embodiment of the current technique, the test case code path vectors are represented as a matrix, with each row corresponding to a test case and each column corresponding to a code path.

In an example embodiment of the current technique, the code path test selection system sorts the test case code path vectors based on a total number of code paths covered by each test case.

In an example embodiment of the current technique, the test cases covering the same number of code paths are sorted by their index.

In an example embodiment of the current technique, the code path test selection system iteratively selects the set of test cases by subtracting a test case code path vector from the test target code path vector to generate an updated target vector, adding a test case to the set of test cases if the updated target vector differs from the test target code path vector, and terminating if the updated target vector contains no positive elements, otherwise continuing the iteratively selecting with the updated target vector in place of the test target code path vector.

In an example embodiment of the current technique, the code path test selection system terminates when all required code paths are covered by the set of test cases.

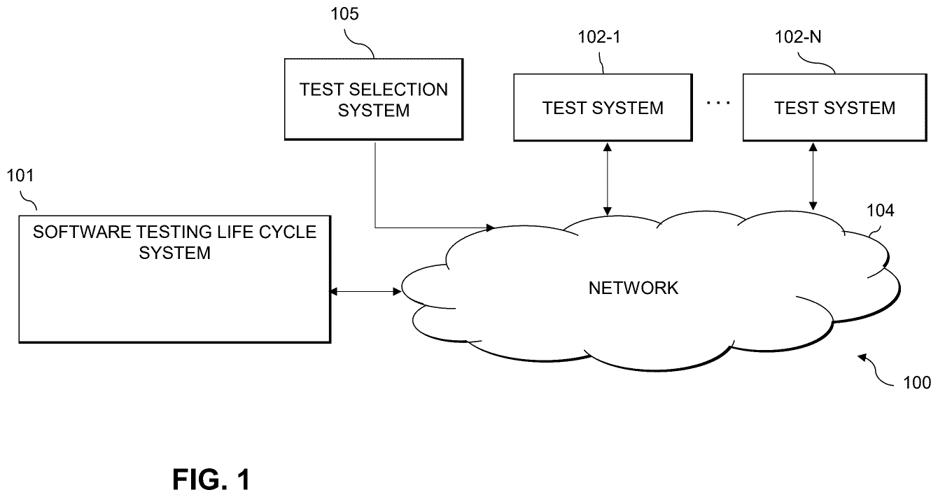

FIG. 1 shows a computer network (also referred to herein as an information processing system) 100 configured in accordance with an illustrative embodiment. The computer network 100 comprises a Continuous Integration/Continuous Delivery (CI/CD) pipeline system 105, a code path test selection system 106, test system 102, and a code repository 101. In an example embodiment, CI/CD as that term is used herein, refers generally to continuous integration, continuous deployment and/or continuous delivery. Such functions or portions thereof are considered to be examples of a “software development process” as that term is broadly used herein. A wide variety of other types of software development processes may be utilized in other embodiments, illustratively relating to integration, deployment and/or other aspects of software development for one or more of the source code that is executed on other systems, for example, on the test system 102 (or multiple test systems 102-N, not shown). The CI/CD pipeline system 105, test system 102, code path test selection system 106, and code repository 101 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a code path test selection system 106 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the CI/CD pipeline system 105, test system 102, code path test selection system 106, and code repository 101 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The CI/CD pipeline system 105, test system 102, code path test selection system 106, and code repository 101 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the code path test selection system 106 are one or more input-output devices, which illustratively comprise keyboards, displays or other types of input-output devices in any combination. Such input-output devices can be used, for example, to support one or more user interfaces to the code path test selection system 106, as well as to support communication between the code path test selection system 106 and other related systems and devices not explicitly shown. For example, a dashboard may be provided for a user to view a progression of the execution of the code path test selection system 106. One or more input-output devices may also be associated with any of the CI/CD pipeline system 105, test system 102, code path test selection system 106, and code repository 101.

Additionally, the code path test selection system 106 in the FIG. 1 embodiment is assumed to be implemented using at least one processing device. Each such processing device generally comprises at least one processor and an associated memory, and implements one or more functional modules for controlling certain features of the code path test selection system 106.

More particularly, the code path test selection system 106 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the code path test selection system 106 to communicate over the network 104 with the CI/CD pipeline system 105, test system 102, code path test selection system 106, and code repository 101 and illustratively comprises one or more conventional transceivers.

A code path test selection system 106 may be implemented at least in part in the form of software that is stored in memory and executed by a processor, and may reside in any processing device. The code path test selection system 106 may be a standalone plugin that may be included within a processing device.

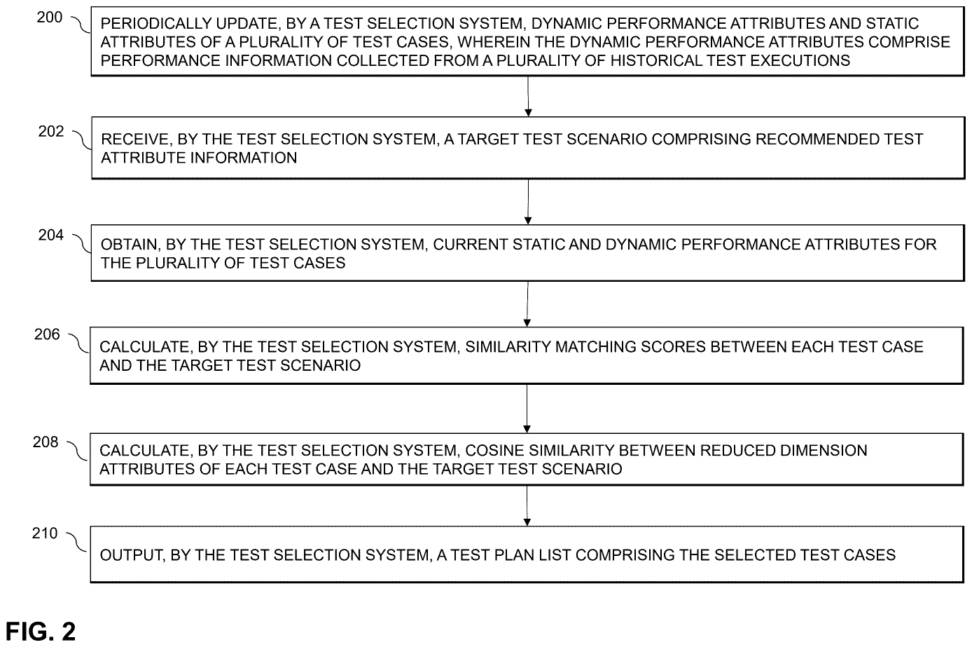

It is to be understood that the particular set of elements shown in FIG. 1 for code path test selection system 106 involving the CI/CD pipeline system 105, test system 102, code path test selection system 106, and code repository 101 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the code path test selection systems 106 can be on and/or part of the same processing platform. An exemplary process of code path test selection system 106 in computer network 100 will be described in more detail with reference to, for example, the flow diagram of FIG. 2.

FIG. 2 is a flow diagram of a process for execution of the code path test selection system 106 in an illustrative embodiment. It is to be understood that this particular process is only an example, and additional or alternative processes can be carried out in other embodiments.

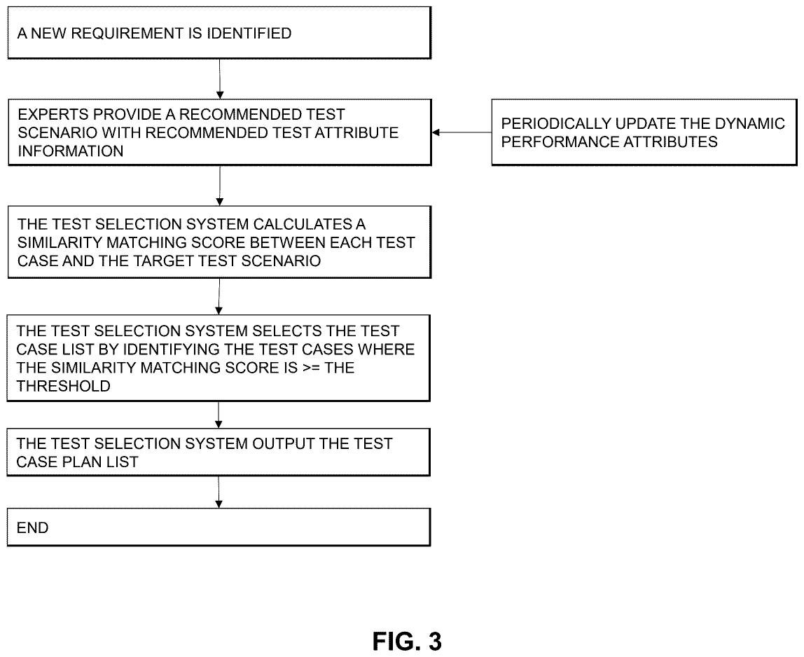

At 200, the code path test selection system 106 defines a multi-level test coverage target based on code paths associated with a plurality of test cases. In an example embodiment, the multi-levels correspond to different test hit rates. FIG. 3 illustrates the principle of multi-level code path coverage test selection. The left side of FIG. 3 illustrates the traditional code path coverage which covers all code paths. The right side of FIG. 3 illustrates the code paths of different colors, where each color represents paths that meet different test intensity requirements. For example, a blue code path requires that the test case covers that code path once, whereas a red code path requires that the test case covers that code path multiple times to ensure that the code path is fully tested.

In an example embodiment, the code path test selection system 106 analyzes the code paths of the plurality of test cases at the module level as the smallest calling unit. The code path is the set of specific instructions that are executed during a single run of a program or program fragment. The line-based code paths are very complex and numerous. The code path test selection system 106 analyzes the module as the smallest calling unit of the code path to ensure the logical integrity of the code path and also to reduce the calculation amount of the code path. In an example embodiment, the multi-level test coverage target enables digital quantification of testing strengths of the plurality of test cases. In an example embodiment, the multi-level test coverage targets are defined according to requirements, and different levels (of the multi-level) correspond to different test hit rates.

At 202, the code path test selection system 106 generates a test target code path vector, Vₜ, representing code paths to be tested, comprising vector elements weighted based on importance of the corresponding code paths. In an example embodiment, the set of code paths for the plurality of test cases is P_{f} where P_{f}={P₁, P₂, P₃, P₄, . . . , Pₙ}. The variable Pᵢ indicates a code path based on function. The code path vector for the plurality of test cases is a 1×n vector represented as V_{f}, where all items have a value of 1, meaning all the code paths Pᵢ are covered. In an example embodiment, the test target code path vector is represented as Vₜ. Each item in Vₜ is mapped to a code path in P_{f}. If the code path Pᵢ has changed, the code path test selection system 106 sets the value to 1. If the code path in Pᵢ has not changed, the code path test selection system 106 sets the value to 0.

$${V}_{t} = \vert {δ}_{i} \vert ( i = 1 , 2 , 3 … , n )$$

$${δ}_{i} = \{ \begin{matrix}0 & ( when {P}_{i} is not included in code change ) \\ 1 & ( when {P}_{i} is included in code change )\end{matrix}$$

The code path test selection system 106 generates the test target code path vector by analyzing code push requests to identify modified code and related code paths associated with the modified code, where the plurality of test cases comprise the modified code. In an example embodiment, the test target code may be a bug fix code change, a feature code change, or any code change requirement to be tested. For example, the code path test selection system 106 generates the test target code path vector, Vₜ, as Vt=[1 0 1 1 1 . . . 1 0]. In an example embodiment, the code path test selection system 106 incorporates the modified code paths and related code paths into the test target code path vector. In an example embodiment, push requests may be analyzed to identify the modified test code, and then obtain the related code paths. In an example embodiment, the weighting of vector elements in the test target code path vector is based on factors comprising complexity of code modification, impact on other modules, and criticality of the module.

In an example embodiment, based on the developers' feedback, the code paths are assigned different weight levels, such as low, medium, and high. For example, a weight of “low” means the number of times the code path should be tested on a test system 102 should be less than a weight of “medium”, and a weight of “high” means the code path should be tested more times than a code path with a weight of “low” or “medium”. In an example embodiment, the weights are assigned numerical values, with higher values corresponding to higher importance levels. For example, the weight of “low” may be assigned “1’, the weight of “medium” may be assigned “5” and the weight of “high” may be assigned 10. In an example embodiment, the code path test selection system 106 represents each test case code path vector as a 1×n vector, where n indicates the number of code paths in the plurality of test cases. In an example embodiment, the code path test selection system 106 sets each element in the test target code path vector to 1 if the corresponding code path has changed and sets it to 0 if the corresponding code path has not changed.

At 204, the code path test selection system 106 generates test case code path vectors representing code paths covered by the plurality of test cases. In an example embodiment, the code path test selection system 106 represents each test case code path vector as a 1×n vector, where n indicates a number of code paths in the plurality of test cases. In an example embodiment, the test case code path vector, V_{c}, indicates the code path for a test case, and represents the runtime code path of a test case. In V_{c}, the items that have a value of 1 indicates the code path Pᵢ is covered by the test case, whereas the items that have a value of 0 indicate the code path Pᵢ is not covered by the test case. For example, V_{c}=[0 0 1 1 0 . . . 00].

$${V}_{c} = \vert {δ}_{i} \vert ( i = 1 , 2 , 3 … , n )$$

$${δ}_{i} = \{ \begin{matrix}0 & ( when {P}_{i} is not covered by test case ) \\ 1 & ( when {P}_{i} is covered by test case )\end{matrix}$$

In an example embodiment, the code path test selection system 106 represents the test case code path vectors as a matrix, with each row corresponding to a test case and each column corresponding to a code path. In an example embodiment, for a plurality of test cases, M, the code path test selection system 106 represents the test case code path array A_{tc} as follows:

$${A}_{tc} = [ \begin{matrix}{V}_{C 1} \\ {V}_{C 2} \\ ⋮ \\ {V}_{Cm}\end{matrix} ]$$

For example:

$$[ \begin{matrix}0 & 1 & … & 1 & 1 \\ 1 & 1 & … & 1 & 0 \\ ⋮ & ⋮ & ⋮ & ⋮ & ⋮ \\ 1 & 0 & … & 0 & 1 \\ 0 & 0 & … & 1 & 0\end{matrix} ]$$

In an example embodiment, the code path test selection system 106 defines the multi-level test target code path vector V′ₜ. As noted above, the code paths may be assigned different weight levels, for example:

$${W}_{t} = \{ \begin{matrix}1 & ( test level = Low ) \\ 5 & ( test level = Medium ) \\ 10 & ( test level = High )\end{matrix}$$

$${V}_{t}^{′} = {V}_{t} * {W}_{t} = [ \begin{matrix}0 & 1 & 0 & 5 & … & 5 & 10 & 0\end{matrix} ]$$

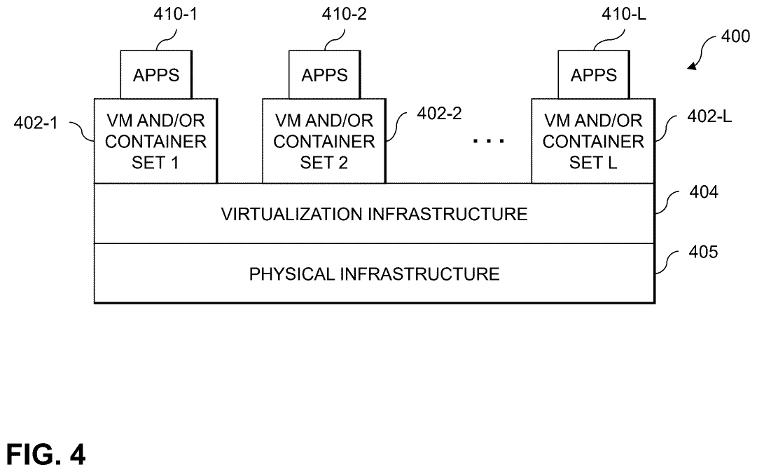

FIG. 4 illustrates the relationship between each vector for the multi-level test coverage based on code path.

In an example embodiment, the code path test selection system 106 sorts every test case in the plurality of test cases, where the plurality of test cases has a connection to a given push request. The code path test selection system 106 defines the vector V_{ci} to represent the run time code path of the test case i, where i stands for index in the plurality of test cases.

In an example embodiment, the code path test selection system 106 sorts the test case code path vectors, V_{c1}, V_{c2}, . . . , V_{cn}, based on a total number of code paths covered by each test case. In an example embodiment, if there are more than one test case that covers the same number of code paths, then those test cases are sorted by their index, i.

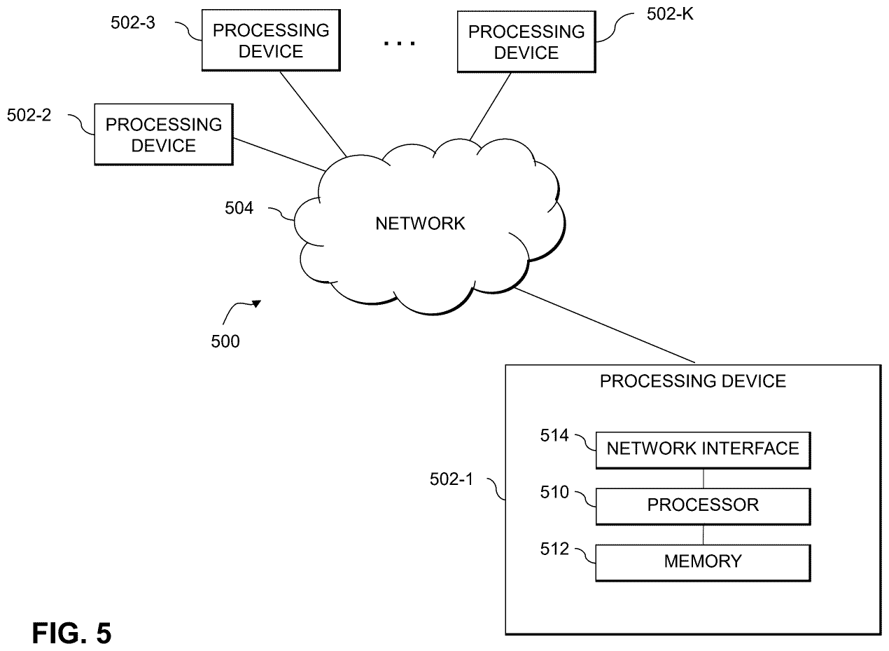

At 206 the code path test selection system 106 selects a set of test cases from the plurality of test cases based on the test case code path vector and the test target code path vector. In an example embodiment, the code path test selection system 106 iteratively selects the set of test cases by subtracting a test case code path vector from the test target code path vector to generate an updated target vector, adding a test case to the set of test cases if the updated target vector differs from the test target code path vector, terminating if the updated target vector contains no positive elements, otherwise continuing the iteratively selecting with the updated target vector in place of the test target code path vector. FIG. 5 illustrates the flow chart of selecting the set of test cases, where the set of test cases is represented by the selected list S.

In an example embodiment, the code path test selection system 106 generates the one-dimensional vector V′ₜ, representing the code paths involved, where the items in the vectors are weighted based on factors such as the complexity of the code modification, whether the code modification affects other modules or not, and whether the module is a crucial module, and identifying all the code paths. Using the sorted group A_{tc}, the code path test selection system 106 subtracts V_{ci} from V′ₜ to obtain V_{tnew} (where all negative values are assigned to 0). The code path test selection system 106 assigns V_{ci} to the selected list S (i.e., the set of test cases) if there are any elements different between V′ₜ and V_{tnew}. In an example embodiment, the code path test selection system 106 terminates the process when all required code paths are covered by the set of test cases. In other words, the code path test selection system 106 terminates the process if there are no positive elements in V_{tnew} (otherwise V_{tnew} is assigned to V′ₜ for another loop in the iterative process.

In an example embodiment, listed below are fifteen test cases (T1 through T15), each covering eight target code paths (P1 through P8).

| | P1 | P2 | P3 | P4 | P5 | P6 | P7 | P8 |
|---|---|---|---|---|---|---|---|---|
| T1 | 1 | 1 | 1 | 1 | 1 | 1 | 0 | 1 |
| T2 | 0 | 1 | 1 | 1 | 1 | 0 | 1 | 0 |
| T3 | 0 | 1 | 1 | 0 | 1 | 1 | 1 | 0 |
| T4 | 0 | 0 | 1 | 0 | 1 | 0 | 1 | 0 |
| T5 | 1 | 1 | 0 | 1 | 1 | 1 | 1 | 1 |
| T6 | 1 | 1 | 1 | 0 | 1 | 1 | 1 | 1 |
| T7 | 1 | 0 | 1 | 0 | 0 | 1 | 0 | 1 |
| T8 | 0 | 1 | 0 | 1 | 0 | 1 | 1 | 1 |
| T9 | 0 | 0 | 1 | 0 | 0 | 1 | 0 | 1 |
| T10 | 0 | 0 | 0 | 1 | 1 | 0 | 1 | 1 |
| T11 | 0 | 0 | 1 | 1 | 0 | 0 | 1 | 1 |
| T12 | 0 | 1 | 1 | 0 | 0 | 1 | 1 | 1 |
| T13 | 1 | 0 | 0 | 1 | 0 | 1 | 0 | 1 |
| T14 | 1 | 1 | 0 | 1 | 1 | 0 | 1 | 1 |
| T15 | 0 | 1 | 0 | 0 | 1 | 1 | 1 | 0 |

In an example embodiment, the code path test selection system 106 creates a one-dimensional vector V′ₜ with 8 elements, each denoting the eight code paths that are connected to a given pull request. Each element's value is weighted, with 1 indicating a low-important code path, 5 indicating a medium-important code path and 10 denoting the most-important code path.

$${V}_{t}^{′} = [ \begin{matrix}0 & 1 & 5 & 1 & 5 & 1 & 10 & 5\end{matrix} ]$$

In an example embodiment, the code path test selection system 106 models the test case code path vector table into two matrices, with the first matrix representing the test case index, and the second matrix representing the relationship between the test case and the code path (where 1 indicates the test case and the code path are connected). FIG. 6 illustrates the case index and the test case code path vector.

In an example embodiment, the code path test selection system 106 generates the test case code path vector, A_{tc}, by sorting the test case code path vector by the number of code paths in descending order. If the same number of code paths are found, the code path test selection system 106 then sorts the test case code path vector by the test case index in ascending order. FIG. 7 illustrates the sorted test case code path vector.

In an example embodiment, the code path test selection system 106 by subtracting a test case code path vector from the test target code path vector to generate an updated target vector. In other words, the code path test selection system 106 subtracts V_{ci} from V′ₜ to obtain V_{tnew}, as illustrated in FIG. 8, and below:

$${V}_{tnew} = {V}_{t}^{′} - {V}_{c 1} = [ \begin{matrix}0 & 0 & 4 & 0 & 4 & 0 & 10 & 4\end{matrix} ]$$

$${V}_{tnew} <> {V}_{t}^{′} \text{=>} put TC 1 to selected list S$$

$$S = [ TC 1 ]$$

$${V}_{tnew} > 0 \text{=>} assign {V}_{tnew} to {V}_{t}^{′} and go to TC 5$$

In an example embodiment, the code path test selection system 106 performs this step iteratively as shown in FIG. 9, and below:

$${V}_{tnew} = {V}_{t}^{′} - {V}_{c 5} = [ \begin{matrix}0 & 0 & 3 & 0 & 3 & 0 & 9 & 3\end{matrix} ]$$

$${V}_{tnew} <> {V}_{t}^{′} \text{=>} put TC 5 to selected list S$$

$$S = [ TC 1 , TC 5 ]$$

In an example embodiment, the code path test selection system 106 continues to perform this step iteratively as shown in FIG. 10, and below:

$${V}_{t}^{′} > 0 \text{=>} assign {V}_{tnew} to {V}_{t}^{′} and go to TC 6$$

$${V}_{tnew} = {V}_{t}^{′} \text{=>} Don ’ t put TC 13 to selected list S .$$

$$S = [ TC 1 , TC 5 , TC 6 , TC 14 , TC 2 , TC 3 , TC 8 , TC 12 , TC 10 , TC 11 ]$$

$${V}_{t}^{′} > 0 \text{=>} assign {V}_{tnew} to {V}_{t} and go to TC 15.$$

In an example embodiment, the code path test selection system 106 performs this step iteratively until there is no difference between Vₜ and V_{C6}, as illustrated in FIG. 11 and below:

$${V}_{tnew} = {V}_{t} - {V}_{c 6} = [ \begin{matrix}0 & 0 & 0 & 0 & 0 & 0 & 0 & 0\end{matrix} ]$$

$${V}_{tnew} <> {V}_{t}^{′} \text{=>} put TC 15 to selected list S$$

$$S = [ TC 1 , TC 5 , TC 6 , TC 14 , TC 2 , TC 3 , TC 8 , TC 12 , TC 10 , TC 11 , TC 15 ]$$

$${V}_{t}^{′} = 0 \text{=>} The selection is done .$$

The set of test cases, S, is then determined to be:

$$S = [ TC 1 , TC 5 , TC 6 , TC 14 , TC 2 , TC 3 , TC 8 , TC 12 , TC 10 , TC 11 , TC 15 ]$$

At 208, the CI/CD pipeline system 105 executes the set of test cases, S on a test system 102 to provide the multi-level test coverage. In an example embodiment, the CI/CD pipeline system 105 triggers the code path test selection system to select the set of test cases to ensure multiple testing of key code paths. For example, the code path test selection system 106 may be incorporated into the CI/CD pipeline system 105 as a stage within the CI/CD pipeline system 105. In an example embodiment, as the test cases are created and/or updated, they are committed to a code repository 101, such as Gitlab.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a method and a system for providing a code path test selection system. These and other embodiments can effectively achieve multi-level test code path coverage to optimize testing quality relative to conventional approaches. For example, embodiments disclosed herein select test cases for testing source code change requirements, such as source code updates, new features and bug fixes based on code paths, to ensure that the selected test cases accurately target the required test points. Embodiments disclosed herein select test cases to test source code by considering the testing intensity of various testing requirements. Embodiments disclosed herein recognize that significant test code paths require a more focused and repeated testing, and apply quantitative methods to achieve multiple coverage of different code paths. Embodiments disclosed herein support a multiple leveled quantitative test coverage of key code paths, ensuring that the key code paths of the key test code modules are covered multiple times to achieve an overall better test quality. Embodiments disclosed herein achieve graded test coverage of testing objectives by multi-level test code path coverage to ensure multiple tests of key modules.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

Illustrative embodiments of processing platforms will now be described in greater detail with reference to FIGS. 12 and 13. Although described in the context of the information processing system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that are utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 comprise respective VMs, respective sets of one or more containers, or respective sets of one or more containers running in VMs. In some implementations of the FIG. 12 embodiment, the VMs/container sets 1202 comprise respective VMs implemented using virtualization infrastructure 1204 that comprises at least one hypervisor.

A hypervisor platform may be used to implement a hypervisor within the virtualization infrastructure 1204, where the hypervisor platform has an associated virtual infrastructure management system. The underlying physical machines comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of the information processing system 100 and includes a plurality of processing devices, denoted 1302-1, 1302-2, 1302-3, . . . 1302-K, which communicate with one another over a network 1304.

The network 1304 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1302-1 in the processing platform 1300 comprises a processor 1310 coupled to a memory 1312.

The processor 1310 comprises a microprocessor, a microcontroller, an application-specific integrated circuit (ASIC), a field-programmable gate array (FPGA) or other type of processing circuitry, as well as portions or combinations of such circuitry elements.

The memory 1312 comprises random access memory (RAM), read-only memory (ROM) or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
defining, by a code path test selection system, a multi-level test coverage target based on code paths associated with a plurality of test cases, wherein the multi-levels correspond to different test hit rates;
generating, by the code path test selection system, a test target code path vector representing code paths to be tested, comprising vector elements weighted based on importance of the corresponding code paths;
generating, by the code path test selection system, test case code path vectors representing code paths covered by the plurality of test cases;
selecting, by the code path test selection system, a set of test cases from the plurality of test cases based on the test case code path vector and the test target code path vector; and
executing, by a Continuous Integration/Continuous Delivery (CI/CD) pipeline system the set of test cases on a test system to provide the multi-level test coverage, wherein the method is implemented by at least one processing device comprising a processor coupled to a memory.

2. The method of claim 1 further comprising:
triggering, by the CI/CD pipeline system, the code path test selection system to select the set of test cases to ensure multiple testing of key code paths.

3. The method of claim 1 wherein the multi-level test coverage target enables digital quantification of testing strengths of the plurality of test cases.

4. The method of claim 1 wherein defining, by the code path test selection system, the multi-level test coverage target comprises:
analyzing the code paths of the plurality of test cases at the module level as the smallest calling unit.

5. The method of claim 1 wherein the test target code path vector is generated by analyzing code push requests to identify modified code and related code paths associated with the modified code, wherein the plurality of test cases comprise the modified code.

6. The method of claim 5 further comprising:
incorporating the modified code paths and related code paths into the test target code path vector.

7. The method of claim 1 wherein the weighting of vector elements in the test target code path vector is based on factors comprising complexity of code modification, impact on other modules, and criticality of the module.

8. The method of claim 7 wherein the weighting of the vector elements is based on low, medium, and high importance levels.

9. The method of claim of 8 wherein the weights are assigned numerical values, with higher values corresponding to higher importance levels.

10. The method of claim 1 wherein generating, by the code path test selection system, the test target code path vector comprises:
representing the test target code path vector as a 1×n vector, wherein n indicates a number of code paths in the plurality of test cases.

11. The method of claim 10 wherein each element in the test target code path vector is set to 1 if the corresponding code path has changed, and set to 0 if the corresponding code path has not changed.

12. The method of claim 1 wherein generating, by the code path test selection system, the test case code path vectors comprises:
representing each test case code path vector as a 1×n vector, wherein n indicates a number of code paths in the plurality of test cases.

13. The method of claim 12 wherein each element in the each test case code path vector is set to 1 if the corresponding code path is covered by the test case, and set to 0 if the corresponding code path is not covered.

14. The method of claim 1 wherein the test case code path vectors are represented as a matrix, with each row corresponding to a test case and each column corresponding to a code path.

15. The method of claim 1 further comprising:
sorting the test case code path vectors based on a total number of code paths covered by each test case.

16. The method of claim 15 wherein test cases covering the same number of code paths are sorted by their index.

17. The method of claim 1 wherein selecting, by the code path test selection system, the set of test cases comprises:
iteratively selecting the set of test cases by:
subtracting a test case code path vector from the test target code path vector to generate an updated target vector;
adding a test case to the set of test cases if the updated target vector differs from the test target code path vector; and
terminating if the updated target vector contains no positive elements, otherwise continuing the iteratively selecting with the updated target vector in place of the test target code path vector.

18. The method of claim 17 wherein the code path test selection system terminates when all required code paths are covered by the set of test cases.

19. A system comprising:
at least one processing device comprising a processor coupled to a memory;
the at least one processing device being configured:
to define, by a code path test selection system, a multi-level test coverage target based on code paths associated with a plurality of test cases, wherein the multi-levels correspond to different test hit rates;
to generate, by the code path test selection system, a test target code path vector representing code paths to be tested, comprising vector elements weighted based on importance of the corresponding code paths;
to generate, by the code path test selection system, test case code path vectors representing code paths covered by the plurality of test cases;
to select, by the code path test selection system, a set of test cases from the plurality of test cases based on the test case code path vector and the test target code path vector; and
to execute, by a Continuous Integration/Continuous Delivery (CI/CD) pipeline system the set of test cases on a test system to provide the multi-level test coverage.

20. A computer program product comprising a non-transitory processor-readable storage medium having stored therein program code of one or more software programs, wherein the program code when executed by at least one processing device causes said at least one processing device:
to define, by a code path test selection system, a multi-level test coverage target based on code paths associated with a plurality of test cases, wherein the multi-levels correspond to different test hit rates;
to generate, by the code path test selection system, a test target code path vector representing code paths to be tested, comprising vector elements weighted based on importance of the corresponding code paths;
to generate, by the code path test selection system, test case code path vectors representing code paths covered by the plurality of test cases;
to select, by the code path test selection system, a set of test cases from the plurality of test cases based on the test case code path vector and the test target code path vector; and
to execute, by a Continuous Integration/Continuous Delivery (CI/CD) pipeline system the set of test cases on a test system to provide the multi-level test coverage.
